(19) United States
(12) Patent Application Publication
(10) Pub. No.: US 2008/0065694 A1
(43) Pub. Date: Mar. 13, 2008

(54) Local Search Using Address Completion

(75) Inventor: Jiang Qian, Pittsburgh, PA (US)

Correspondence Address: GOOGLE / FENWICK, SILICON VALLEY CENTER, 801 CALIFORNIA ST., MOUNTAIN VIEW, CA, 94041, US

(73) Assignee: GOOGLE INC., Mountain View, CA (US)

(21) Appl. No.: 11/752,191

(22) Filed: May 22, 2007

Related U.S. Application Data
(60) Provisional application No. 60/825,088, filed on Sep. 8, 2006.

(51) Int. Cl. G06F 17/00

(52) U.S. Cl. 707/104.1; 707/E17.032

(57) ABSTRACT

A local search server receives queries for information about businesses from clients. The local search server searches a local information database for information about a business and reports the information about the business to the client that requested it. Sometimes, the database lacks complete information for the business. For example, the database might be missing the street number for the business. The local search server obtains the missing information by interfacing with a search engine and searching for hosted documents about the business. The local search server receives snippets of text from the documents. The local search server applies one or more heuristics to the text snippets to determine the missing information. The missing information is saved in the local information database.

### CROSS-REFERENCE TO RELATED APPLICATION

This application claims the benefit of U.S. Provisional Application No. 60/825,088, filed Sep. 8, 2006, which is hereby incorporated by reference herein.

### BACKGROUND OF THE INVENTION

1. Field of the Invention

This invention pertains in general to computerized information retrieval and in particular to systems for providing information about businesses or other entities within a specified geographic area.

2. Description of the Related Art

A local search service allows a user to search for businesses within her or his local geographic area. Oftentimes, the user will provide a search query that describes the name or type of a business. In return, the local search service returns a list of one or more businesses that match the search query. The local search service also returns additional information about a matching business, such as the address and a map showing its location. The local search service uses a geocoding process to generate the map. The geocoding process accepts an input string describing a location, and returns the latitude and longitude of that location.

In some geographic areas, such as the country of China, address information is difficult to obtain. Business listing data (e.g., “yellow pages” data) can be obtained from commercial data vendors, but these data often lack street numbers and/or other information. Therefore, it is difficult for a local search service to provide complete addresses and maps in response to search queries.

In one local search service, when the address to be geocoded includes a street but lacks a street number, the geocoding process computes the center of the street and returns the latitude and longitude of the center. The local search service then displays a map showing the street's center. However, this technique is misleading for long streets, because the center might in fact be a long way from the business supposedly being shown on the map.

Accordingly, there is a need in the art for a more efficient way to determine complete address information for businesses and other entities.

### BRIEF SUMMARY OF THE INVENTION

The above and other needs are met by a method, system, and computer program product for determining information about a business. An embodiment of the method comprises receiving a query for information about the business, and identifying information about the business that is missing from a local information database. The method obtains snippets of text of documents hosted by document hosts and containing information about the business. The method further analyzes the snippets to determine the information about the business that is missing from the local information database.

Embodiments of the system and computer program product comprise a query module for receiving a query for information about the business and a local search module for interfacing with a local information database and identifying information about the business that is missing from the database. The system and computer program product further comprise a search engine interface module for obtaining snippets of text of documents hosted by document hosts and containing information about the business, and a snippet analysis module for analyzing the snippets to determine the information about the business that is missing from the local information database.

### BRIEF DESCRIPTION OF THE DRAWINGS

FIG. 1 is a high-level block diagram of a computing environment according to one embodiment of the present invention.

FIG. 2 is a high-level block diagram illustrating a functional view of a typical computer for use as a client, local search server, data supplier, and/or document host like those illustrated in the environment of FIG. 1 according to one embodiment.

FIG. 3 is a high-level block diagram illustrating modules within the local search server according to one embodiment.

FIG. 4 is a flowchart illustrating steps performed by the address completion module according to one embodiment.

FIG. 5 is a flowchart illustrating steps performed by the local search server when responding to a client query according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION

### I. Overview

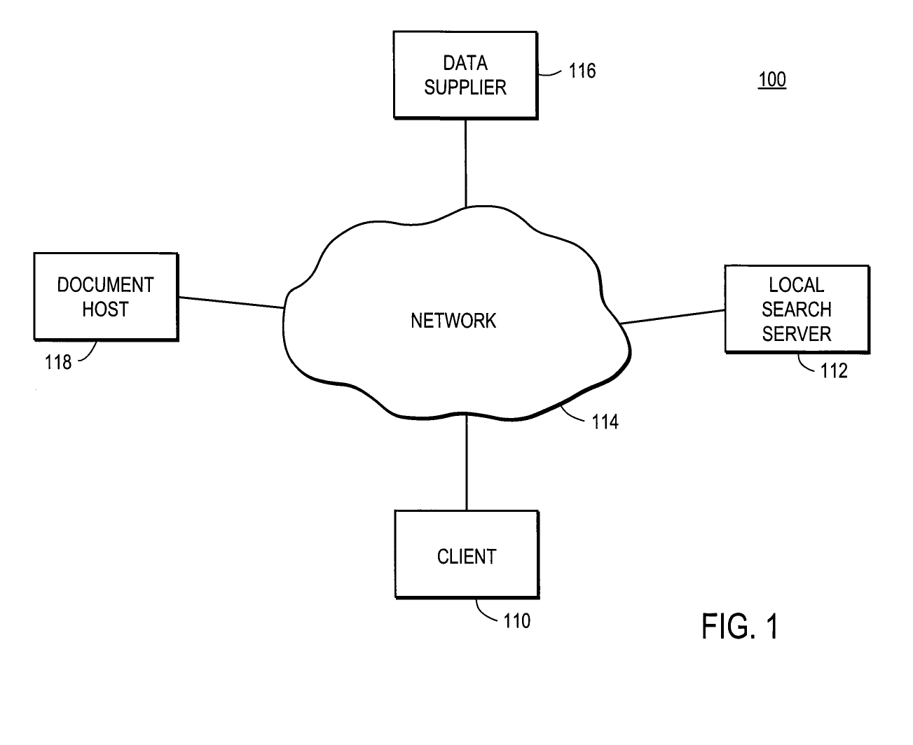

FIG. 1 is a high-level block diagram of a computing environment 100 according to one embodiment of the present invention. FIG. 1 illustrates a client 110 and a local search server 112 connected to a network 114. A data supplier 116 and document host 118 are also connected to the network 114. Although FIG. 1 illustrates only a single client 110, embodiments can have thousands or millions of clients interacting with the server. Likewise, there can be thousands or millions of document hosts 118 on the network 114. There can also be multiple data suppliers 116 and/or local search servers 112. Only one of each entity is illustrated in order to simplify and clarify the present description.

The client 110 represents a device utilized by an end-user to interact with the server 112 via the network 114 in order to conduct searches for local information and obtain the information in response. In one embodiment, the client 110 is a computer having standard networking functionality. In some embodiments, the client 110 is a mobile device such as a notebook computer, a mobile telephone, a personal digital assistant (PDA), a portable email device, a handheld game device, an automobile navigation system, or another type of device with equivalent functionality. The client 110 communicates with the server 112 using standard networking technologies, including wired and/or wireless network links using computer and/or mobile telephone communications protocols.

The client 110 includes functionality for submitting requests to the server 112, and for providing the received information to the end-user. In some embodiments, the client 110 includes a keyboard for inputting the requests, and a display device for viewing the information. In other embodiments, the client 110 includes additional and/or different functionality for performing these tasks, such as a touch screen-based input device and/or an audio output device.

In one embodiment, the client 110 includes web-browsing functionality that allows it to use standard Internet communications technologies to exchange messages with the server 112. For example, the client 110 can execute a web browser such as MICROSOFT INTERNET EXPLORER®, a browser optimized for mobile devices such as OPERA MOBILE™ and OPERA MINI™, and/or another browser that allows the end-user to retrieve and display content from web servers and other computer systems on the network 114.

The data supplier 116 includes a server computer operated by a commercial data vendor or other similar entity. In one embodiment, the data supplier 116 provides listing data (e.g., “yellow pages” data) about businesses and other entities within specified geographic areas to the local search server 112. The listing data may include complete addresses for some businesses and partial addresses for others.

The document host 118 stores electronic documents that are accessible via the network 114. A document is comprised of any machine-readable data including any combination of text, graphics, multimedia content, etc. A document may be encoded in a markup language, such as the hypertext markup language (HTML), i.e., a web page, in a interpreted language (e.g., JavaScript) or in any other computer readable or executable format. A document stored by the document host 118 is typically identified by a Uniform Resource Locator (URL), or any other appropriate form of identification and/or location. In one embodiment, the document host 118 is a web site operated by a web server. The single document host 118 shown in FIG. 1 represents the vast number of web sites and web pages that are accessible via the network 114.

The local search server 112 receives queries from clients 110 and provides information in return. In one embodiment, a query is for information about businesses within a particular geographic region. The local search server 112 provides the client 110 with information about the businesses that satisfy the query. The information about a business can include, for example, an address or other location information, business hours, a phone number, an editorial review of the business, user-submitted ratings of the business, etc. In addition, an embodiment of the local search server 112 provides the client with a map displaying the location of the business.

Sometimes, the local search server 112 lacks complete address information for a business. The server 112 may have general address information that it obtained from the data supplier 116, such as the name of the business and its city, district, and street, but lack a specific street address (number) or other data that are required to determine the exact location of the business and show it on a map. The local search server 112 identifies businesses for which it lacks complete address data and attempts to determine the businesses' complete addresses. An embodiment of the local search server 112 analyzes documents stored on the document hosts 118 to determine the complete addresses for the businesses. This analysis can be performed independently of any requests received from the clients 110. For example, the analysis can be performed as a preprocessing step before the information in the local search server 112 is made available to the clients. Once the complete address for a business is determined, the local search server 112 stores the address and provides it in response to client requests.

As used herein, the term “business” encompasses commercial and non-commercial entities, including entities such as schools, libraries, hospitals and the like that might not traditionally be considered businesses. All of these entities are referred to herein as “businesses” for purposes of simplicity and clarity. Similarly, this description uses the term “local” because the queries receive by the local search server 112 are often restricted to a particular geographic area such as neighborhood, district, city, state, province, and/or country. However, the queries need not be “local” to the end-user and can span one or more geographic areas.

The network 114 represents the communication pathways among the clients 110, local search server 112, document hosts 118, and data suppliers 116. In one embodiment, the network 114 is the Internet. The network 114 can also utilize dedicated or private communications links that are not necessarily part of the Internet. In one embodiment, the network 114 uses standard communications technologies and/or protocols. Thus, the network 114 can include links using technologies such as Ethernet, 802.11, integrated services digital network (ISDN), digital subscriber line (DSL), asynchronous transfer mode (ATM), etc., as well as links using mobile telephone communications technologies. Similarly, the networking protocols used on the network 114 can include multiprotocol label switching (MPLS), the transmission control protocol/Internet protocol (TCP/IP), the hypertext transport protocol (HTTP), the simple mail transfer protocol (SMTP), the file transfer protocol (FTP), the short message service (SMS) protocol, etc. The data exchanged over the network 114 can be represented using technologies and/or formats including the HTML, the extensible markup language (XML), the Extensible Hypertext markup Language (XHTML), the compact HTML (cHTML), etc. In addition, all or some of links can be encrypted using conventional encryption technologies such as the secure sockets layer (SSL), HTTP over SSL (HTTPS), and/or virtual private networks (VPNs). In other embodiments, the clients 110 and routing server 112 use custom and/or dedicated data communications technologies instead of, or in addition to, the ones described above.

### II. System Architecture

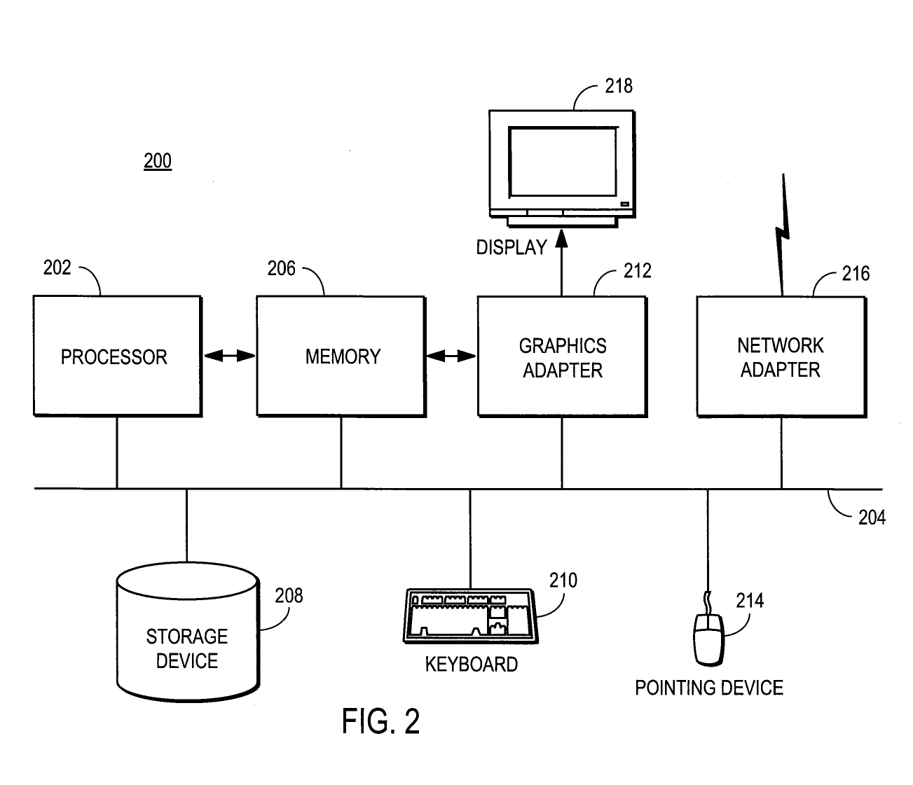

FIG. 2 is a high-level block diagram illustrating a functional view of a typical computer 200 for use as a client 110, local search server 112, data supplier 116, and/or document host 118 like those illustrated in the environment 100 of FIG. 1 according to one embodiment. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any general-purpose processor such as an INTEL x86 compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer 200 to the network 114.

As is known in the art, the computer 200 is adapted to execute computer program modules. As used herein, the term “module” refers to computer program logic and/or data for providing the specified functionality. A module can be implemented in hardware, firmware, and/or software. In one embodiment, the modules are stored on the storage device 208, loaded into the memory 206, and executed by the processor 202.

The types of computers 200 utilized by the entities of FIG. 1 can vary depending upon the embodiment and the processing power utilized by the entity. For example, the client 110 typically requires less processing power than the local search server 112. Thus, the client 110 can be a standard personal computer system or handheld electronic device. The local search server 112, in contrast, may comprise more powerful computers and/or multiple computers working together to provide the functionality described here. Likewise, the computers 200 can lack some of the components described above. For example, a mobile phone acting as a client 110 may lack a pointing device, and a computer acting as the local search server 112 may lack a keyboard and display.

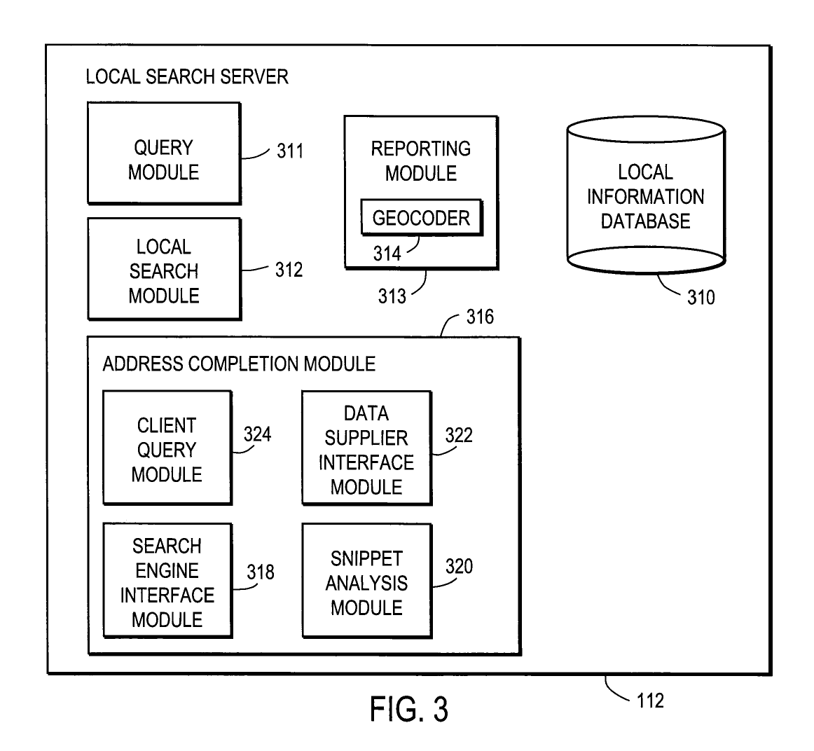

FIG. 3 is a high-level block diagram illustrating modules within the local search server 112 according to one embodiment. Other embodiments have different and/or additional modules than the ones shown in FIG. 3. Moreover, other embodiments distribute the functionalities among the modules in a different manner.

A local information database 310 stores information about businesses within one or more geographic areas. The information can include, for example, the full name, complete address, and telephone numbers for the business. In addition, the information can include a link to the business's web page and other pages about the business, end-user supplied ratings and reviews, business hours, accepted forms of payment, photos, menus, whether parking is available, etc.

A query module 311 receives a search query from the client 110 and/or another entity. In one embodiment, the query describes the name and/or type of a business for which information is desired. The query can also specify other search parameters, such as a geographic area to which the search is restricted, a partial address of the business, etc. An embodiment of the query module 311 utilizes conventional parsing techniques to parse the query, extract the search terms, and characterize the terms as potential business names, geographic areas, and/or other identifiers. A local search module 312 executes a query on the local information database 310 for the information requested by the client query and receives in response a list of one or more businesses satisfying the query, along with additional information about the businesses.

A reporting module 313 reports information about a business to the end-user of a client 110. In one embodiment, the reporting module 313 reports the information about a business retrieved from the local information database 310 by the local search module 312. For example, the report generated by the reporting module 313 can include a web page that lists information about the businesses that match the search query received by the query module 311. In addition, the report can include detailed information about one or more businesses selected from among the listed businesses.

In one embodiment, a report from the reporting module 313 includes a map showing the location of the business. An embodiment of the reporting module 313 uses a geocoder module 314 to convert the address of the business into a corresponding latitude and longitude (and/or another representation suitable for mapping). The reporting module 313 generates a map highlighting the location at the latitude/longitude, and provides the map as part of the report. The reporting module 313 thus shows the precise location of the business on the map.

As described above, the information about local businesses in the local information database 310 might at least initially lack complete information for some businesses. Typically, the data from the data supplier 116 that are used to initially populate the database 310 contain more information about well known businesses, and less information (e.g., partial addresses) for lesser-known businesses. In some geographic areas, such as certain regions of China, complete addresses including street numbers are difficult to obtain from any data supplier. Thus, the local information database 310 might initially lack complete addresses for many businesses in those areas.

An address completion module 316 determines missing address information for businesses identified in the local information database 310. Generally, the address completion module 316 determines enough address information for a business in order to allow the location of the business to be shown on a map, to allow driving directions to be computed for the business, and the like. A “complete” address as described herein need not have completely all address information for a business. Some information, such as the business's floor in a high-rise building, might be absent.

In one embodiment, the address completion module 316 operates asynchronously from the query-related modules within the local search server. For example, the address completion module 316 can operate as part of a preprocessing step to add address information to the local information database 310 before the database is utilized to respond to queries. Similarly, the address completion module 316 can operate as a background process that adds address information to the database 310 at the same time the database is being used to respond to queries. In another embodiment, the address completion module 316 executes in real-time to determine address information for businesses identified in a list of results produced in response to a query.

FIG. 3 illustrates multiple modules within the address completion module 316. Other embodiments have different and/or additional modules than the ones shown in FIG. 3. Moreover, other embodiments distribute the functionalities among the modules in a different manner. In some embodiments the address completion module 316 itself executes on a server other than the local search server 112. For example, the address completion module 316 can execute on one or more other servers in order to update the local information database 310.

A search engine interface module 318 executes a search of document hosts 118 for documents that describe the business. In one embodiment, the search engine interface module 318 interfaces with a search engine provided by GOOGLE INC. of Mountain View, Calif. The search engine interface module 318 causes the search engine to search for documents containing terms matching the known address information for the business (or a subset of the known address information). The search engine returns snippets of text from the documents that satisfy the query. These snippets include text from the documents that occur near the search terms.

In one embodiment, the search engine interface module 318 filters the businesses having incomplete addresses in order to exclude certain businesses from the address completion process. The address completion process is not used for certain types of businesses, such as parking lots. In addition, the search engine interface module 318 preprocesses the existing address information in order to augment and/or optimize the search. In one embodiment, the search engine interface module 318 determines whether the known address information for a business describes a district within a city. If so, the search engine interface module 318 augments the search query by including the name of the city. Depending upon the embodiment, the city name can be included instead of the district name, or the city name can be an additional query term.

A snippet analysis module 320 analyses the document snippets received by the search engine interface module 318 in order to identify missing address information for a business. An embodiment of the snippet analysis module 320 applies one or more of a variety of heuristics to the snippets in order to identify the missing information. The heuristics applied in a given instance can depend on factors such as the language in which the search results are presented, the type of missing address information that is sought, the type of business, and/or other factors.

An embodiment of the snippet analysis module 320 normalizes the information in the snippets into a canonical format. If there are multiple ways to describe a street address, the street address is normalized into a canonical format. In China, for example, numbers can be represented in number form, and in Chinese character form. An embodiment of the snippet analysis module 320 normalizes such addresses into number form.

When analyzing individual snippets to identify a street number or other component of the address, one embodiment of the snippet analysis module 320 determines whether the name of the business appears before the address in the snippet. Only addresses occurring after the business name are considered as potential correct addresses.

Moreover, an embodiment of the snippet analysis 320 module favors more precise information over less precise information. For example, if two street matches are found in a snippet and only the second match has a number, the snippet analysis module 320 treats the second street match as the address of the business. Conversely, if a single snippet contains two different addresses of equal precision (e.g., two different street numbers), an embodiment of the snippet analysis module 320 favors the first address appearing in the snippet. In addition, if a snippet contains multiple different addresses, an embodiment of the snippet analysis module 320 favors addresses that occur more frequently and/or occur earlier in the snippet than other addresses. If there are multiple snippets with inconsistent address information, an embodiment of the snippet analysis module 320 favors snippets from documents that have titles that include the name of the business over snippets from documents with other titles. Similarly, if the snippet includes a cross street in the address, an embodiment of the snippet analysis module 320 favors the street having the street number and uses that street and number as the address. If the snippet includes a cross street but lacks a street number, an embodiment of the snippet analysis module 320 infers a street number based on the cross street.

An embodiment of the address completion module 316 also includes a client query module 324. In embodiments where the address completion module 316 operates in real-time upon receipt of a query, this module 324 queries the end-user of the client 110 for address completion information. Sometimes the end-user knows the complete address for a business. Accordingly, the client query module 324 interacts with the end-user to obtain the address. In one embodiment, the client query module 324 queries the end-user for the actual street number or other address information. In another embodiment, the client query module 324 uses another technique to query the end-user, such as asking the end-user to identify cross-street near the business. The client query module 324 for example, can provide the end-user with a series of web pages, pop-up windows, and/or other UI tools to query the end-user and receive the information in return.

Further, an embodiment of the address completion module 316 includes a data supplier interface module 322 for interfacing with one or more data suppliers 116 to obtain missing address information for a business. Sometimes, address information that is not available from one data supplier 116 is available from an alternate data supplier. One embodiment of the data supplier interface module 322 attempts to obtain the address information from one or more alternate data suppliers 116.

### III. Process/Example

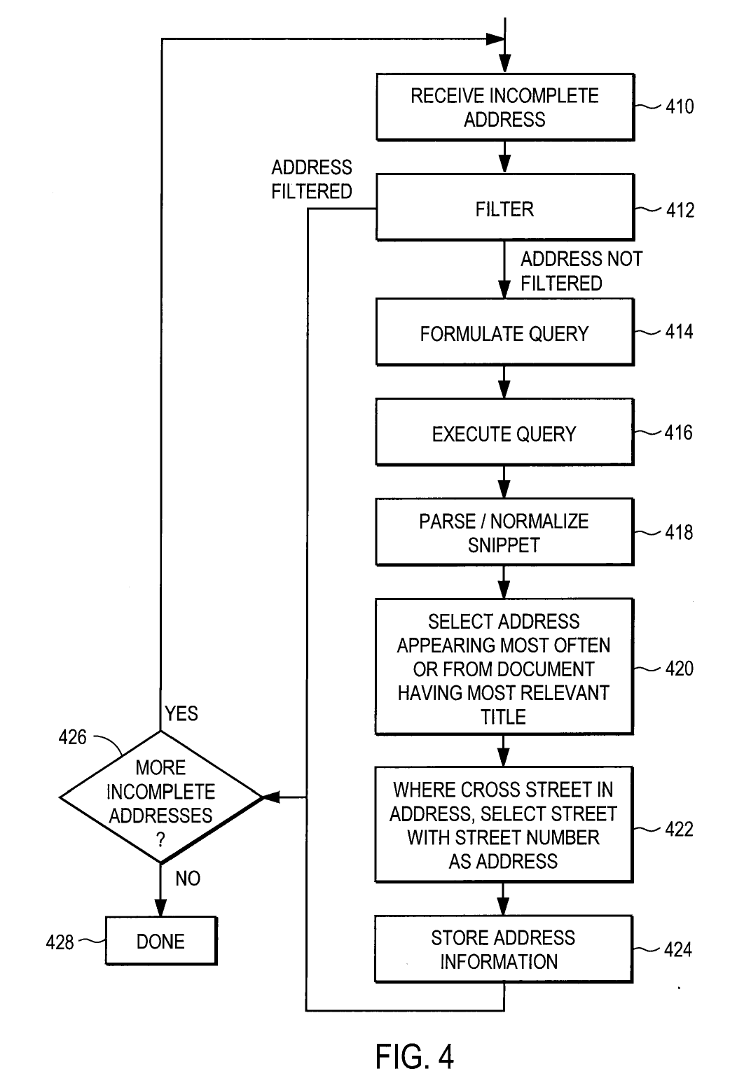

FIG. 4 is a flowchart illustrating steps performed by the address completion module 316 according to one embodiment. Other embodiments perform additional and/or different steps that the ones described in the figure. In addition, other embodiments perform the steps in different orders and/or perform multiple steps concurrently.

The address completion module 316 receives 410 an incomplete address for a business. For example, the incomplete address can be received from the local information database 310 or from a data supplier 116. The address completion module 316 filters 412 the address information based on the type of business and/or other factors. The existing address information may indicate that the business is a parking lot or other type of business for which the address completion is not used. Therefore, the address completion module 316 skips processing of the address.

If processing is not skipped, the address completion module 316 formulates a query 414 based on the existing address information for the business. The address completion module 316 may optimize and/or augment the query by adding additional terms such as the name of a city containing a district mentioned in the known address information. The address completion module 316 executes the query 416 to search document hosts 118 on the network 114 for documents containing information about the business.

The address completion module 316 analyzes snippets of documents returned by the search engine in order to determine the complete address for the business. In one embodiment, this analysis involves parsing 418 the snippets to identify names, numbers, street names, and the like contained within them. In addition, information in the snippets, such as numbers, is normalized 418 into canonical formats.

An embodiment of the address completion module 316 selects 420 the address information appearing most frequently in the returned snippets. For example, if the known address information is missing the street address for a business, the address completion module 316 selects the street number appearing most frequently in the returned snippets. Similarly, an embodiment selects 420 the address information appearing in the snippet from the document having the most relevant title. For example, if the title of a web page contains the name of the business for which the address information is sought, then this title/web page is more relevant than other titles/web pages. The address completion module 316 therefore uses the address information from the more relevant page. If an address appearing in a snippet includes a street name and address, and the name of a cross street, an embodiment of the address completion module 316 selects 422 the street with the street number and uses it as the address information. If the snippet includes a cross street but lacks a street number, the address completion module 316 infers 422 a street number based on the cross street.

The address completion module 316 stores 424 the complete address information as determined from the analysis of the snippets in the local information database 310. If 426 there are more incomplete business addresses in the database 310, the address completion module 316 processes the next one. Otherwise, the process terminates 428.

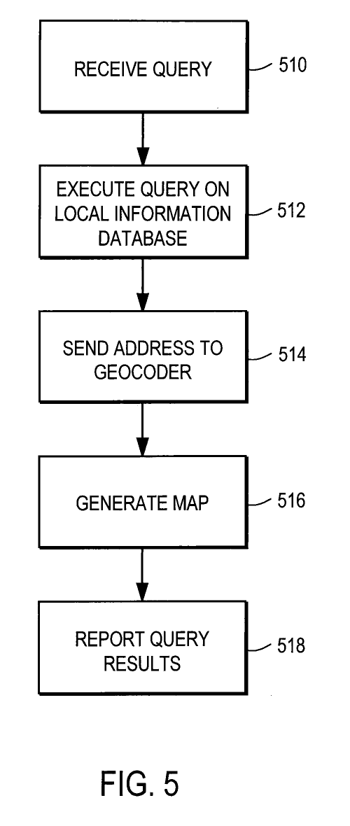

FIG. 5 is a flowchart illustrating steps performed by the local search server 112 when responding to a client query according to one embodiment. Other embodiments perform additional and/or different steps that the ones described in the figure. In addition, other embodiments perform the steps in different orders and/or perform multiple steps concurrently. In one embodiment, the local search server 112 simultaneously serves thousands or millions of clients 110, and thus performs many instances of the steps concurrently.

Initially, the local search server 112 receives 510 a query from a client 110 and/or another entity. The local search server 112 executes 512 a search on the local information database 310 for businesses matching the query. Assume that the local information database 310 contains complete address information for a business that matches the query, either because complete information was received from the data supplier 116, or the address completion module 316 determined the complete address.

The local search server 112 provides 514 the complete address to the geocoder module 314 which, in turn, converts the address into the equivalent latitude and longitude. The local search server 112 uses the output of the geocoder module 314 to generate 516 a map showing the location of the business. The server 112 reports the results of the query, including the map, to the client 110.

For example, assume that the local information database 310 contains an entry titled “Wal-Mart,” and that this entry contains the address information “Freeport Road, Pittsburgh Pa.” An embodiment of the local search server 112 uses the search engine to search for documents from document hosts 118 having the terms “Wal-Mart,” “Freeport,” “Road,” “Pittsburgh,” and “PA” in order to ascertain the complete address. In return, the search engine returns the snippet:
Wal-Mart Store 877 Freeport Road, Pittsburgh, Pa. 15238. Wal-Mart Super Center 250 Summit Park Drive, Pittsburgh, Pa. 15275. Select from the listings above
   The local search server 112 uses heuristics to parse this snippet and determines that “877” is the street number for the Wal-Mart store on Freeport Road in Pittsburgh, Pa. In response to a query from a client 110, the local search server 112 uses the geocoder module 314 to generate a map that accurately identifies the location of the store and reports this result to the client.

In other embodiments, the techniques described herein are used for purposes other than local search. For example, the techniques can be used to generate facts for a general fact repository that stores information from documents hosted by document hosts 118. In addition, the techniques can be used to obtain information other than address information.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A computer-implemented method of determining information about a business, comprising:
identifying information about the business that is missing from a local information database;
obtaining snippets of text from documents hosted by document hosts and containing information about the business;
analyzing the snippets to determine the missing information about the business; and
storing the determined information in the local information database.

2. The method of claim 1, wherein the missing information is a street number for the business.

3. The method of claim 1, wherein the local information database includes known information describing a district of a city in which the business is located, and wherein obtaining snippets of text comprises:
searching for documents containing a name of the city having the district in which the business is located.

4. The method of claim 1, wherein analyzing the snippets comprises:
obtaining the missing information from a snippet of a document having a name of the business in its title.

5. The method of claim 1, wherein a snippet contains multiple terms arranged in a sequence, at least one term is a name of the business, and wherein analyzing the snippets comprises:
obtaining the missing information from terms of the snippet that occur after the name of the business in the sequence.

6. The method of claim 1, wherein analyzing the snippets comprises:
normalizing information in the snippets into a canonical format.

7. The method of claim 1, further comprising:
receiving a query for information about the business.

8. The method of claim 7, wherein the query for information about the business is received from a client and further comprising:
reporting information about the business contained in the local information database and the determined missing information to the client.

9. A system for determining information about a business, comprising:
a local search module for interfacing with a local information database and identifying information about the business that is missing from the database;
a search engine interface module for obtaining snippets of text from documents hosted by document hosts and containing information about the business;
a snippet analysis module for analyzing the snippets to determine the missing information about the business; and
a completion module for storing the determined information in the local information database.

10. The system of claim 9, wherein the local information database includes known information describing a district of a city in which the business is located, and wherein the search engine interface module is adapted to cause the search engine to search for documents containing a name of the city having the district in which the business is located.

11. The system of claim 9, wherein the snippet analysis module is further adapted to obtain the missing information from a snippet of a document having a name of the business in its title.

12. The system of claim 9, wherein a snippet contains multiple terms arranged in a sequence, at least one term is a name of the business, and the snippet analysis module is further adapted to obtain the missing information from terms of the snippet that occur after the name of the business in the sequence.

13. The system of claim 9, wherein the snippet analysis module is further adapted to normalize information in the snippets into a canonical format.

14. The system of claim 9, further comprising:
a query module for receiving a query for information about the business.

15. The system of claim 14, wherein the query for information about the business is received from a client and further comprising:
a reporting module for reporting information about the business contained in the local information database and the determined missing information to the client.

16. A computer program product having a computer-readable storage medium having computer program code embodied therein for determining information about a business, comprising:
a local search module for interfacing with a local information database and identifying information about the business that is missing from the database;
a search engine interface module for obtaining snippets of text from documents hosted by document hosts and containing information about the business;
a snippet analysis module for analyzing the snippets to determine the missing information about the business; and
a completion module for storing the determined information in the local information database.

17. The computer program product of claim 16, wherein the local information database includes known information describing a district of a city in which the business is located, and wherein the search engine interface module is adapted to cause the search engine to search for documents containing a name of the city having the district in which the business is located.

18. The computer program product of claim 16, wherein the snippet analysis module is further adapted to obtain the missing information from a snippet of a document having a name of the business in its title.

19. The computer program product of claim 16, wherein a snippet contains multiple terms arranged in a sequence, at least one term is a name of the business, and the snippet analysis module is further adapted to obtain the missing information from terms of the snippet that occur after the name of the business in the sequence.

20. The computer program product of claim 16, wherein the snippet analysis module is further adapted to normalize information in the snippets into a canonical format.

21. The computer program product of claim 16, further comprising:
a query module for receiving a query for information about the business.

22. The computer program product of claim 21, wherein the query for information about the business is received from a client and further comprising:
a reporting module for reporting information about the business contained in the local information database and the determined missing information to the client.
